(19) United States
(12) Patent Application Publication
(10) Pub. No.: US 2026/0186779 A1
(43) Pub. Date: Jul. 2, 2026

(54) METHOD FOR PROCESSING INSTRUCTION AND PROCESSOR MODULE THEREFOR

(71) Applicant: UNIVERSITY OF SEOUL INDUSTRY COOPERATION FOUNDATION., Seoul (KR)

(72) Inventor: Dong Hee LEE, Seoul (KR)

(21) Appl. No.: 18/863,833

(22) PCT Filed: Jun. 23, 2022
(86) PCT No.: PCT/KR2022/008913

§ 371 Date: Nov. 7, 2024

(30) Foreign Application Priority Data
May 11, 2022 (KR) 10-2022-0057742

(51) Int. Cl. G06F 9/38; G06F 9/355

(52) U.S. Cl. CPC G06F 9/3004; G06F 9/355

(57) ABSTRACT

A method for processing an instruction includes storing a result of execution of an instruction in a table, calculating an index pointing to a specific entry in the table by using an opcode of the instruction and at least one operand, searching for the specific entry by using the index and transmitting data stored in the searched specific entry to a destination register or a memory.

### TECHNICAL FIELD

The present disclosure relates to a method and processor module for processing an instruction.

### BACKGROUND

A processor is one of the main components of a computer and functions to execute instructions. Each instruction is executed through a fetch stage, a decode stage, and an execute stage. When an instruction is executed, the processor can store the result of the execution of that instruction in a register or memory within the processor.

The processor includes a plurality of registers. For example, a program counter (PC) register holds a memory address of an instruction to be fetched next by the processor. Instructions fetched by the processor are stored in an instruction resister (IR). A Flag or PSW (Program Status Word) register is a special register that indicates the status of a program or result values, such as zero, positive, negative, overflow, underflow, equal, greater than, less than, less than or equal to, and greater than or equal to.

An accumulator register is configured to store operation results. Also, the processor includes various registers configured to store data or indices.

The execution of an instruction begins with the fetch stage where the instruction is fetched from the memory. Specifically, the processor fetches the instruction and an operand from the memory. Then, the instruction is decoded and executed. Also, if necessary, other data or operands required for execution of the instruction can be fetched from the memory. Finally, the result of the execution is stored in the register or memory.

In the fetch stage, the processor fetches an instruction from the memory and stores the instruction in the IR. In the fetch stage, the processor may fetch an additional operand from the memory if necessary.

In the decode stage, the processor decodes the instruction in the IR and generates micro-steps or a sequence of signals required to execute the instruction.

In the execution stage, the processor provides the micro-steps or the sequence of signals to the register or an arithmetic and logic unit (ALU) and performs an arithmetic or logical operation. Also, the result of the execution is stored in a predetermined register or a register specified by the instruction.

A memory write stage may be optionally performed as a fourth stage. The memory write stage is required if the result is stored in the memory, but the memory write stage may not be required if the result is not stored in the memory.

Meanwhile, pipelining similar to an assembly line can be applied to the processor to improve the performance of the processor. A pipelining processor can simultaneously perform different stages for different instructions.

Assuming an instruction i is fetched at time t, the instruction i is decoded and an instruction i+1 is fetched at time t+1. At time t+2, the instruction i is executed, the instruction i+1 is decoded, and an instruction i+2 is fetched. In this way, according to the pipelining technique, the processor can simultaneously perform various stages for various instructions.

Another technique, superscalar, can be applied to the processor to improve the performance of the processor. A superscalar processor uses a plurality of hardware resources to fetch and execute a plurality of instructions simultaneously.

Very Long Instruction Word (VLIW) is yet another technique to improve the performance of the processor. To use the VLIW technique, a VLIW needs to be created by combining a plurality of instructions and operands. The processor fetches the VLIW and simultaneously executes a plurality of instructions in the VLIW.

Unlike the superscalar technique which requires a lot of hardware resources, the VLIW technique improves the performance of the processor with the help of a compiler instead of hardware resources. The compiler needs to create a single VLIW by gathering a plurality of instructions that can be executed simultaneously.

An instruction for the processor may be composed of an opcode and optionally one or more operands. For example, an ADD instruction may be composed of one opcode and two operands. Here, the opcode is a bit code indicating the operation to be executed by the processor. The operands can be register numbers, memory addresses, or immediate values. The instruction may also optionally include a destination register or memory address to store a result.

The processor has a lot of instructions. For example, the processor may have instructions for arithmetic operations, such as ADD, SUBTRACT, MULTIPLY, DIVIDE, and MODULAR. An ADD instruction adds two operands and stores the result in the register or memory. A SUBTRACT instruction subtracts two operands and stores the result in the register or memory. A MULTIPLY instruction multiplies operands, the DIVIDE instruction divides operands, and a MODULAR instruction obtains the remainder of a division operation.

The processors also has instructions for logical operations, such as AND, OR, XOR, and NOT. These instructions perform the corresponding operations, and operation results are stored in the register or memory.

A COMPARE (or TEST) instruction compares (tests) operands and stores the result of the test in the Flag (or PSW) register.

The bits in the Flag register indicate whether the result of the test is zero, negative, positive, greater than, less than, greater than or equal to, or less than or equal to zero.

Arithmetic, logical, and comparison operations are performed by the ALU. For example, the ADD operation is performed by an adder in the ALU, and the SUBTRACT operation is also converted to addition by adding the 2's complement and performed by the adder in the ALU. Likewise, logical and comparison operations are also performed by the ALU.

Each of these instructions requires different energy consumption and execution time from each other.

While the MULTIPLY instruction, the DIVIDE instruction, and the MODULAR instruction are slow and consume a lot of energy, the ADD instruction, the SUBTRACT instruction, and the COMPARE instruction are fast and consume less energy. However, basically, the execution of all the instructions takes time and consumes energy.

Each processor may have a multi-core architecture with a plurality of cores embedded in a chip. Also, the processor operates at several gigahertz. As a result, the processor consumes a lot of energy and emits heat.
(Patent Document 1) Korean Patent Laid-open Publication No. 1995-0025536 (published on Sep. 18, 1995)

### DISCLOSURE OF THE INVENTION

### Problems to be Solved by the Invention

In view of the foregoing, the present disclosure is conceived to store the result of the execution of an instruction in a table, search for a specific entry in the table by using an index pointing to the specific entry in which the result of execution is stored, and transmit data stored in the searched specific entry to a destination register or memory.

However, the problems to be solved by the present disclosure are not limited to the above-described problems. There may be other problems to be solved by the present disclosure.

### Means for Solving the Problems

According to an aspect of the present disclosure, a method for processing an instruction includes storing a result of execution of an instruction in a table, calculating an index pointing to a specific entry in the table by using an opcode of the instruction and at least one operand, searching for the specific entry by using the index and transmitting data stored in the searched specific entry to a destination register or a memory.

According to another aspect of the present disclosure, a processor module for processing an instruction includes a storage unit configured to store a result of execution of an instruction in a table, a decoder configured to calculate an index pointing to a specific entry in the table by using an opcode of the instruction and at least one operand, an entry search unit configured to search for the specific entry by using the index and a transmission unit configured to transmit data stored in the searched specific entry to a destination register or a memory.

The above-described aspects are provided by way of illustration only and should not be construed as liming the present disclosure. Besides the above-described embodiments, there may be additional embodiments described in the accompanying drawings and the detailed description.

### Effects of the Invention

According to any one of the above-described means for solving the problems of the present disclosure, it is possible to store a result of execution of an instruction in a table, search for a specific entry in the table by using an index pointing to the specific entry in which the result of execution is stored, and transmit data stored in the searched specific entry to a destination register or a memory.

Also, according to the present disclosure, it is possible to search for a result of calculation from a table when a processor executes an instruction, and if the result of calculation is present in the table, it is possible to fetch the result of calculation from the table and thus possible to avoid the execution of unnecessary operations (e.g., operations of an ALU for calculation).

Therefore, according to the present disclosure, it is possible to reduce the time and energy required to execute an instruction and reduce heat generation of the processor. Further, according to the present disclosure, it is possible to provide a method for executing an instruction more quickly while consuming less energy.

Furthermore, according to the present disclosure, it is possible to solve energy consumption and heat generation problems in a multi-core architecture processor equipped with a plurality of cores.

### BRIEF DESCRIPTION OF THE DRAWINGS

FIG. 1 is a block diagram of a processor module according to an embodiment of the present disclosure.

FIG. 2A is a diagram for explaining a method for processing an instruction according to an embodiment of the present disclosure.

FIG. 2B is a diagram for explaining the method for processing an instruction according to an embodiment of the present disclosure.

FIG. 3 is a diagram for explaining a decode stage and an execute stage for a MULTIPLY instruction according to an embodiment of the present disclosure.

FIG. 4 is a diagram for explaining a method for calculating an index for the MULTIPLY instruction according to an embodiment of the present disclosure.

FIG. 5 is a diagram for explaining a method for calculating an index for a MULTIPLY instruction according to another embodiment of the present disclosure.

FIG. 6 is a diagram for explaining a method for reducing the table size according to an embodiment of the present disclosure.

FIG. 7 is a diagram for explaining a method for reducing the table size according to another embodiment of the present disclosure.

FIG. 8 is a diagram for explaining a method for sharing a table by different instructions according to an embodiment of the present disclosure.

FIG. 9 is a flowchart showing a method for processing an instruction according to an embodiment of the present disclosure.

### BEST MODE FOR CARRYING OUT THE INVENTION

Hereinafter, embodiments of the present disclosure will be described in detail with reference to the accompanying drawings so that the present disclosure may be readily implemented by a person with ordinary skill in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Additionally, when a part “includes” one element, this means that it may further include another element rather than excluding another element, unless specifically stated to the contrary.

Through the whole document, the term “unit” includes a unit implemented by hardware, a unit implemented by software, and a unit implemented by both of them. One unit may be implemented by two or more pieces of hardware, and two or more units may be implemented by one piece of hardware.

Through the whole document, a part of an operation or function described as being carried out by a terminal or device may be carried out by a server connected to the terminal or device. Likewise, a part of an operation or function described as being carried out by a server may be carried out by a terminal or device connected to the server.

Hereinafter, the present disclosure will be explained in detail with reference to the accompanying configuration views or process flowcharts.

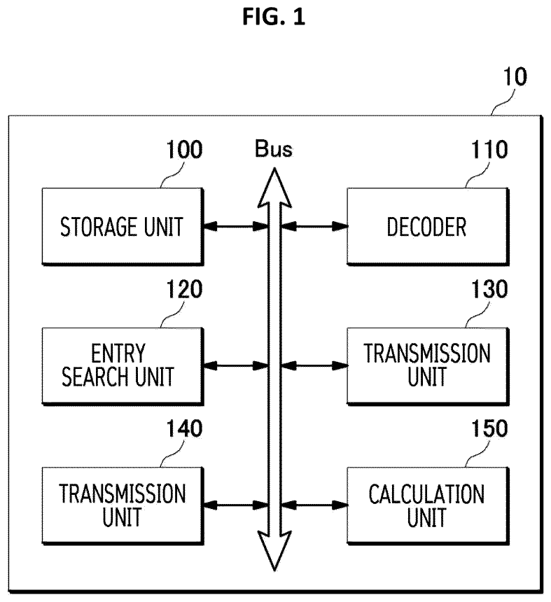

FIG. 1 is a block diagram of a processor module 10 according to an embodiment of the present disclosure.

Referring to FIG. 1, the processor module 10 may include a storage unit 100, a decoder 110, an entry search unit 120, a transmission unit 130, a determination unit 140, and a calculation unit 150. However, the processor module 10 illustrated in FIG. 1 is merely an embodiment of the present disclosure, and various modifications may be made on the basis of the components illustrated in FIG. 1.

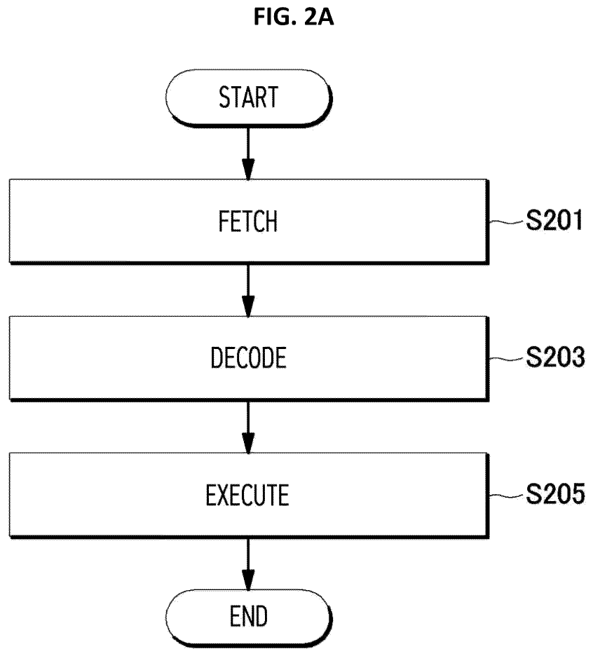

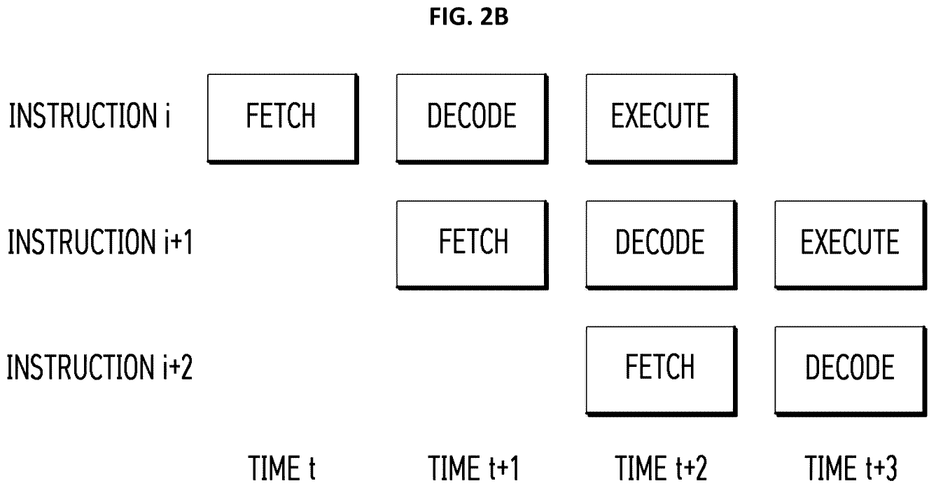

Hereafter, FIG. 1 will be described with reference to FIG. 2A to FIG. 8.

First, a method for processing an instruction according to the present disclosure will be generally described with reference to FIG. 2A and FIG. 2B.

Referring to FIG. 2A, the processor module 10 may fetch an instruction from a memory and store it in an IR in a process S201. In a process S203, the processor module 10 may decode the instruction in the IR and calculate an index pointing to an entry in the table as a result of decoding. Herein, a result of execution of the instruction (calculation result) is stored in the entry in the table. In a process S205, the processor module 10 may fetch the result of execution of the instruction from the entry in the table by using the calculated index and transmit it to a destination register or a memory specified by the instruction.

The processor 10 repeatedly performs these three stages (fetch stage, decode stage, and execute stage).

According to an embodiment of the present disclosure, an instruction is executed through a fetch stage, a decode stage, and an execute stage. An additional stage may be performed besides these three stages. Also, the fetch stage, the decode stage, and the execute stage may be divided into finer stages, and each finer stage may be considered an independent stage.

FIG. 2B illustrates the fetch stage, the decode stage, and the execute stage performed in a pipeline form. First, an instruction i is fetched from the memory and stored in the IR at time t. An instruction i+1 is fetched at time t+1, and the instruction i is decoded at the same time. An instruction i+2 is fetched at time t+2, and the instruction i+1 is decoded and the instruction i is executed at the same time. In this way, a pipelining processor can simultaneously perform different stages for different instructions. Also, a superscalar processor fetches, decodes, and executes a plurality of instructions simultaneously.

Referring back to FIG. 1, the storage unit 100 may store results of execution of a plurality of instructions (operation results) in a table (i.e., a specific entry in the table). Herein, the table includes a plurality of entries, and the results of execution of instructions are stored in each entry.

When an instruction is fetched and stored in the IR, the decoder 110 may decode the instruction stored in the IR and calculate an index pointing to a specific entry in the table (i.e., a specific entry in which the instruction is stored) as a result of decoding.

Specifically, the decoder 110 may calculate an index pointing to a specific entry in the table by using an opcode of the instruction and at least one operand. Herein, the result of execution of the instruction may be stored in the specific entry.

For example, a MULTIPLY operation may have three operands, such as “MUL r0, r1, r2”. A MUL instruction adds values present in registers r0 and r1 and stores the result of the addition in a register r2. In response to the MUL instruction, the decoder 110 may calculate an index by performing a combine operation with the opcode of the MUL instruction and the values present in the registers r0 and r1.

Herein, the combine operation can be represented by the symbol ⊙. The combine operation may be performed through bit concatenation and other operations.

Herein, the index pointing to the specific entry for the MUL instruction can be calculated by performing the combine operation as shown in [Equation 1].

$$Index <= opcode ( MUL ) ⊙ value ( r 0 ) ⊙ value ( r 1 ) \qquad [ Equation 1 ]$$

For example, as for a MUL instruction composed of “MUL #v1, r1, r2” with a direct value #v1 as an operand, the decoder 110 may calculate an index pointing to a specific entry in a table in which a result of execution of “MUL #v1, r1, r2” is stored, as shown in [Equation 2].

$$Index <= opcode ( MUL ) ⊙ \# v 1 ⊙ value ( r 1 ) \qquad [ Equation 2 ]$$

For example, as for a MUL instruction composed of “MUL #v1, #v2, r2” with direct values #v1, #v2 as operands, the decoder 110 may calculate an index pointing to a specific entry in a table in which a result of execution of “MUL #v1, #v2, r2” is stored, as shown in [Equation 3].

$$Index <= opcode ( MUL ) ⊙ \# v 1 ⊙ \# v 2 \qquad [ Equation 3 ]$$

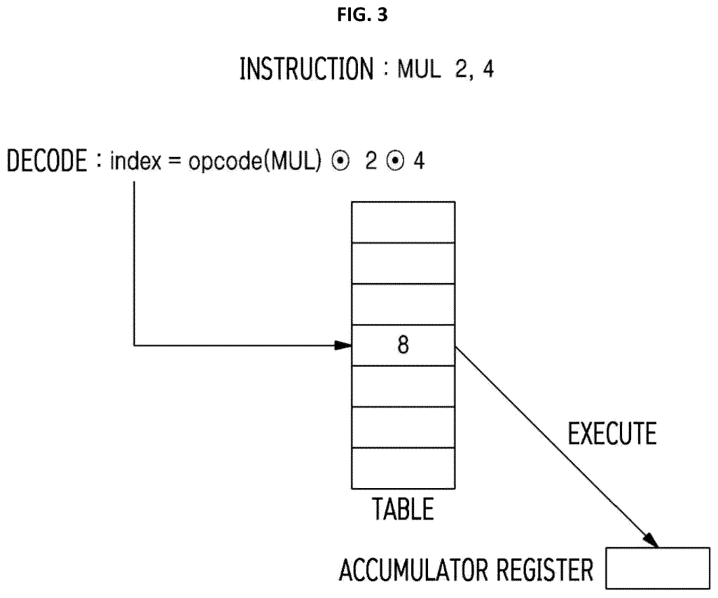

For example, referring to FIG. 3, as for a MUL instruction composed of “MUL 2, 4” with direct values 2 and 4 as operands, the decoder 110 may calculate an index pointing to a specific entry in a table in which “8”, a result of execution of “MUL 2, 4”, is stored, as shown in [Equation 4].

$$Index <= opcode ( MUL ) ⊙ 2 ⊙ 4 \qquad [ Equation 4 ]$$

The decoder 110 may calculate an index pointing to a specific entry in the table through a combine operation by using an opcode of an instruction, at least one operand, and additional information, as shown in one of [Equation 5] to [Equation 7].

$$Index <= opcode ( MUL ) ⊙ value ( r 0 ) ⊙ value ( r 1 ) ⊙ Info \qquad [ Equation 5 ]$$

$$Index <= opcode ( MUL ) ⊙ \#v 1 ⊙ value ( r 1 ) ⊙ Info \qquad [ Equation 6 ]$$

$$Index <= opcode ( MUL ) ⊙ \#v 1 ⊙ \# v 2 ⊙ Info \qquad [ Equation 7 ]$$

Meanwhile, when the index is calculated, address decoding logic partially composed of hardware circuits may be used.

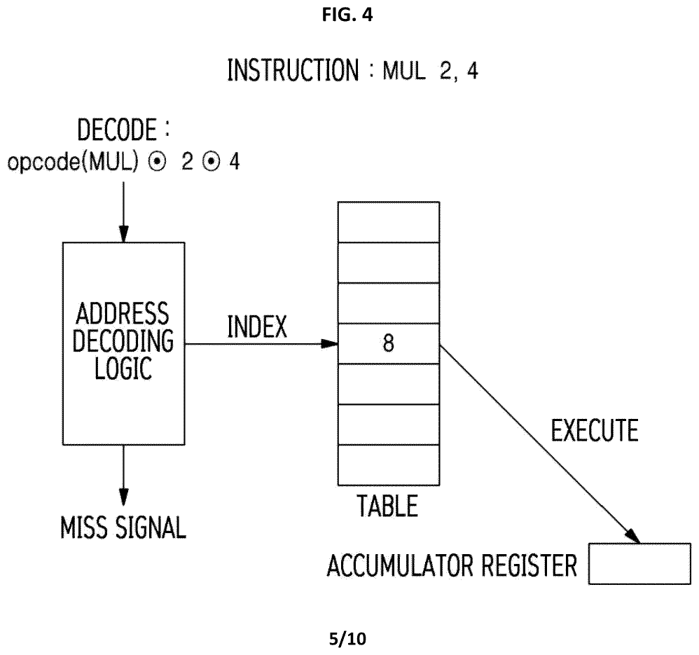

Referring to FIG. 4, when the decoder 110 inputs an opcode and an operand of an instruction (e.g., MUL 2, 4) (or an opcode, an operand, and additional information) to the address decoding logic, the address decoding logic may output an index pointing to a specific entry in a table.

If the specific entry does not exist in the table or the table containing the specific entry does not exist, the address decoding logic may output a miss signal.

If the address decoding logic outputs a miss signal, the corresponding instruction can be executed in the conventional manner.

Meanwhile, according to the present disclosure, when the index is calculated, all bits of an operand may not be used, but only some of the bits constituting the operand (i.e., bits that do not have a predetermined bit pattern) may be selectively used.

When a plurality of bits included in at least one operand has a predetermined pattern, the decoder 110 may calculate an index pointing to a specific entry in the table by using bits other than the predetermined pattern among the plurality of bits. Herein, bits having the predetermined pattern may be, for example, all “0” or all “1”.

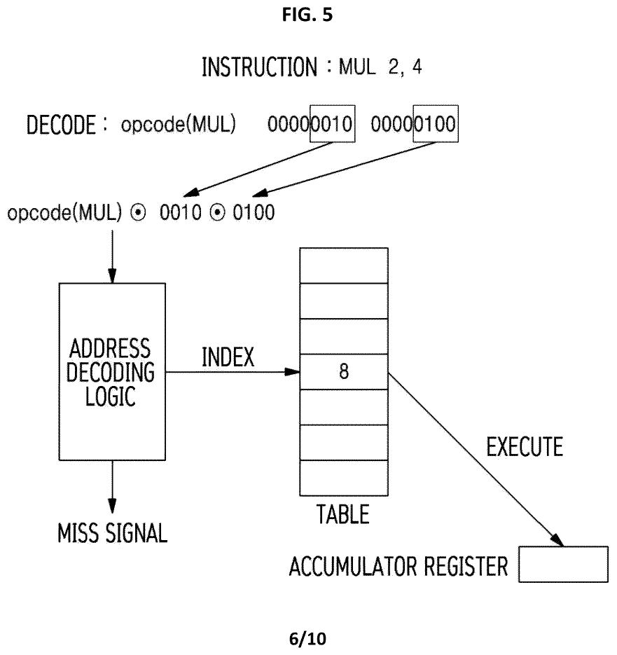

For example, referring to FIG. 5, when a MUL instruction composed of “MUL 2, 4” has direct values 2 and 4 as operands, the decoder 110 may select only 4 bits (“0010” for direct value 2 and “0100” for direct value 4) among 8 bits representing each of direct values 2 and 4 and calculate an index pointing to a specific entry in the table, as shown in [Equation 8]. Herein, all the unselected bits are “0”. If the unselected bits do not have a predetermined bit pattern, the corresponding MUL instruction can be executed in the conventional manner.

$$Index <= opcode ( MUL ) ⊙ 0010 ⊙ 0100 \qquad [ Equation 8 ]$$

In the above-described embodiment of the present disclosure, the table that stores a result of execution of the MUL instruction may include 2⁴*2⁴ entries.

According to the present disclosure, the index is calculated by using only some bits of the operand as described above. This allows the table to store results for only a specific range of operand values without needing to maintain results for all possible operand values. Therefore, the table size can be limited.

The entry search unit 120 may use the calculated index to search the table for a specific entry pointed to by the index.

As described above, according to the present disclosure, it is possible to avoid the execution of unnecessary ALU operations by storing results of execution of instructions in a table instead of executing the instructions directly in the ALU, and searching for and using the results of execution in the table.

If the specific entry pointed to by the index does not exist in the table or the table containing the specific entry does not exist, the corresponding instruction can be executed in the ALU in the conventional manner.

The transmission unit 130 may transmit data stored in the searched specific entry to a destination register or a memory.

For example, if a MUL instruction composed of “MUL r0, r1, r2” designates a register r2 as a destination register, a result of execution of the MUL instruction is transmitted to the register r2. As another example, referring to FIG. 3, if a destination register is not specified in a MUL instruction composed of “MUL r0, r1” (e.g., MUL 2, 4), a result of execution of the MUL instruction is transmitted to a predetermined register, such as an accumulator register.

According to yet another embodiment of the present disclosure, a COMPARE (or TEST) instruction may have two operands, such as “COMPARE r1, r2”. In this case, the decoder 110 may calculate an index by applying a combine operation with values in opcodes of r1 and r2 of the COMPARE instruction. When a specific entry pointed to by an index is searched, the transmission unit 130 may transmit data stored in the searched specific entry to a Flag (or PSW) register or a destination register specified by the instruction. If the specific entry does not exist, the COMPARE (or TEST) instruction can be executed in the conventional manner.

Various types of instructions, such as DIVIDE, MODULE, ADD, and SUBTRACT, can also be decoded and executed in the same manner as described above. Specifically, an index is calculated through a combine operation by using opcodes, operands, and additional information, and the corresponding instructions can be executed by transmitting values of a table entry pointed to by the index to a destination register or memory.

The decoding and execution method of the present disclosure may be applied to all instructions including the instructions described in the above embodiments.

Ideally, if all necessary tables can be maintained in a processor, the methods of the present disclosure may be applied to the combination of all operands of all instructions. However, in reality, the space inside the processor is limited. Therefore, techniques to store all tables and thus reduce the table size are needed.

The determination unit 140 may determine whether a bit string predictable from an opcode or at least one operand exists in the table based on the range for the instruction and the at least one operand.

When the bit string (i.e., a bit string with a pattern) that is predictable from the opcode of the instruction or the at least one operand exists in the table (i.e., data stored in an entry in the table), the storage unit 100 may store the remaining bit strings except for the predictable bit string in the entry in the table. In this case, the table size can be reduced by maintaining only the unpredictable bit strings in the entry in the table.

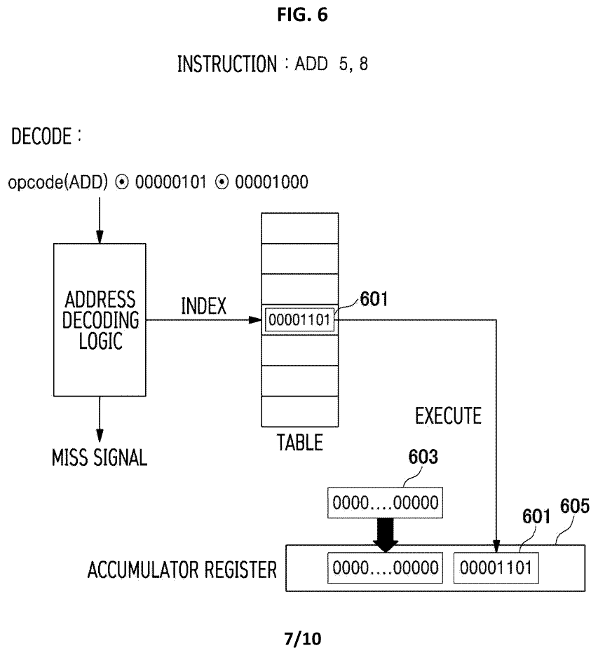

For example, referring to FIG. 6, as for an ADD instruction composed of “ADD 5, 8”, the storage unit 100 stores “00001101”, an unpredictable 8-bit value 601, except “0000 . . . 0000”, a predictable bit string, among results of execution of “ADD 5, 8” in an entry in a table.

For example, an ADD instruction composed of “ADD #v1, #v2” has two operands #v1, #v2. If the operands #v1, #v2 are smaller than 127, a result of execution of the ADD instruction is smaller than 2⁸. In this case, the entry size of a table that stores the result may be 8 bits.

Referring back to FIG. 6, when the ADD instruction composed of “ADD 5, 8” is executed, a predictable bit value 603 is filled with 0s and an unpredictable 8-bit value 601 is fetched from the entry in the table, and they are combined to derive a final result value 605.

Meanwhile, the table may include a plurality of entries with duplicate values. All but one of these duplicate entries may be removed. For example, a MUL instruction composed of “MUL r1, r2” has the same value as a MUL instruction composed of “MUL r2, r1”.

As for the above-described instructions (i.e., instructions “MUL r1, r2” and “MUL r2, r1” with the same result of execution), the decoder 110 may alter the order of at least one operand included in the instructions to calculate a plurality of indices pointing to a specific entry in the table.

For example, a first index for “MUL r1, r2” may be calculated as shown in [Equation 9], and a second index for “MUL r2, r1” may be calculated as shown in [Equation 10].

$$First index = opcode ( MUL ) ⊙ value ( r 1 ) ⊙ value ( r 2 ) \qquad [ Equation 9 ]$$

$$Second index = opcode ( MUL ) ⊙ value ( r 2 ) ⊙ value ( r 1 ) \qquad [ Equation 10 ]$$

Herein, the entries pointed to by the first and second indices in the table have the same result value. In this case, the storage unit 100 may delete all but one of a plurality of duplicate entries pointed to by the first and second indices from the table. Herein, a plurality of indexes may point to the same data in the table, and, thus, the table size can be reduced by removing extra entries with the same data.

When the instruction composed of “MUL r1, r2” is decoded, the decoder 110 may calculate all of a plurality of indices (first and second indices) by altering the order of the operands r1 and r2.

The entry search unit 120 may search the table for entries pointed to by a plurality of indices.

The entry search unit 120 may fetch data from an entry among the entries pointed to by the plurality of indices in the table indicated by a plurality of indexes. If all the entries pointed to by the plurality of indices do not exist in the table, the corresponding instruction can be executed in the conventional manner.

The transmission unit 130 may transmit data stored in the searched entries pointed to by the plurality of indices to the destination register or the memory.

Meanwhile, in order to reduce the table size, the calculation unit 150 may divide each of the first and second operands into predetermined sizes when the operands include a first operand and a second operand, and may calculate a final result value of the instruction by combining partial products calculated using the divided first operand and the divided second operand. Hereinafter, this method will be referred to as a “value-dividing” method.

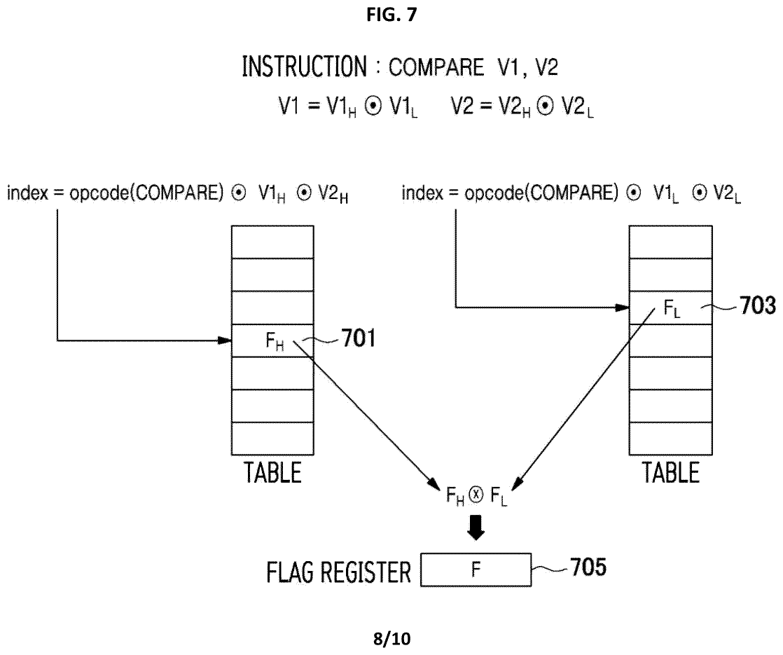

For example, referring to FIG. 7, an operand of a COMPARE instruction composed of “COMPARE V1, V2” can be divided into smaller pieces. The COMPARE instruction has two operands V1 and V2, and both values V1 and V2 can be 32-bit values. The COMPARE instruction compares the values V1 and V2 and stores a result of comparison in the Flag register. In this case, the table needs to include 4G*4G (=2³²*2³²) entries in order to store result values of all possible combinations of two 32-bit operands.

In this case, the calculation unit 150 may divide the 32-bit value V1 into 16-bit values v1_{H} and V1_{L} and the 32-bit value V2 into 16-bit values v2_{H} and v2^{L}.

The calculation unit 150 calculates a first index by combining an opcode of the COMPARE instruction and two operands v1_{H} and v2_{H}.

The entry search unit 120 may search the table for an entry pointed to by the first index and fetch a first partial product (F_{H}) 701 from the searched entry.

Also, the calculation unit 150 calculates a second index by combining the opcode of the COMPARE instruction and two operands v1_{L} and v2_{L}.

The entry search unit 120 may search the table for an entry pointed to by the second index and fetch a second partial product (F_{L}) 703 from the searched entry.

In this case, the number of entries in the table required to store results of execution of the COMPARE instruction, which compares two 16-bit values, may be 16K*16K (=2¹⁶*2¹⁶).

The calculation unit 150 may calculate a final result value (F) 705 of the COMPARE instruction by combining the first partial product (F_{H}) 701 and the second partial product (F_{L}) 703 through a composite operation. Herein, the composite operation can be represented by symbol ⊗ as shown in FIG. 7.

The composite operation can be calculated as follows.

$$\begin{matrix}Zero bit of F = 1 , but if all zero bits {F}_{H} and {F}_{L} are 1 , it is 0. \\ Equal bit of F = 1 , but if all equal bits {F}_{H} and {F}_{L} are 1 , it is 0.\end{matrix}$$

As in the above embodiment of the present disclosure, the table size can be reduced by dividing the operand into smaller pieces, and the final result value can be obtained by combining partial products obtained from the small divided pieces.

Herein, only the partial products (operation results) of the divided operands are stored in the table. Thus, the table size can be reduced.

In another embodiment, an operand of a DIVIDE instruction composed of “DIVIDE r1, #v2” is divided. In this case, the calculation unit 150 may divide a 32-bit value r1 into two 16-bit values v1 and v1. Then, the calculation unit 150 may calculate a result value Res by using the operand #v2 of the DIVIDE instruction, v1H, and v1. The calculation unit 150 may calculate a final result value Res by applying a DIVIDE operation (“/”), an ADD operation (“+”), and a MODULO operation (“%”) as shown in [Equation 11].

$$\begin{matrix}{R}_{H} = v {1}_{H} / \# v 2 \\ Mod 1 = v {1}_{H} \% \# v 2 \\ {R}_{L} = ( Mod 1 ⊙ v {1}_{L} ) / \# v 2 \\ Res = {R}_{H} ⊗ {R}_{L}\end{matrix} \qquad [ Equation 11 ]$$

The DIVIDE instruction that divides a 32-bit operand can be executed through two DIVIDE operations for dividing a 16-bit operand, one MODULO operation, and one ADD operation. As described above, various operations can be performed to obtain partial products. Herein, a final result value Res can be calculated by combining partial products Ry and Rz.

As described above, the technique of reducing the table size by dividing an operand into smaller pieces may be applied to all instructions including the instructions described in the above embodiments.

Meanwhile, instructions may share an entry in a table to reduce the table size. For example, indices for an instruction “ADD 10, 0” and an instruction “ADD 10, 2” may point to two different entries in the same table. In this way, the ADD instructions may share one table for different operands.

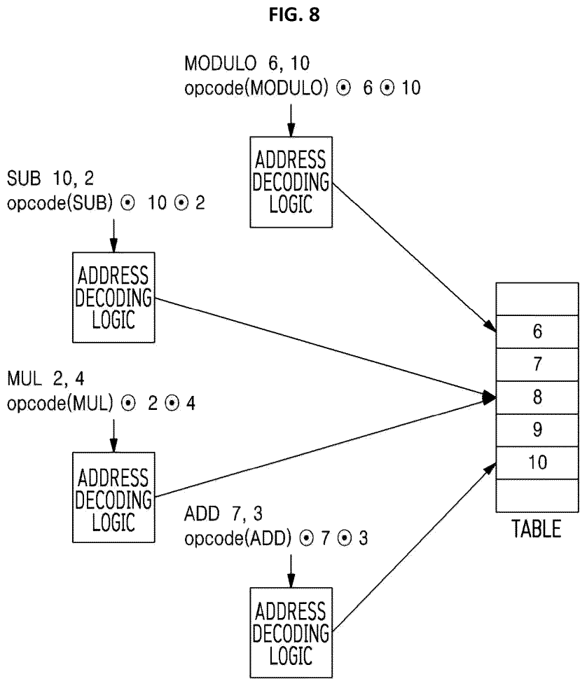

For example, referring to FIG. 8, if the result values are the same, instructions, such as SUBTRACT, ADD, MUL, and MODULO, may share the same table.

All instructions including the instructions described in the above embodiments can share the table.

The storage unit 100 may selectively maintain only the entry pointed to by frequently used indices in the table or may selectively maintain only the entry pointed to by recently used indices in the table. Thus, the table size can be reduced.

Modern processors have a plurality of cores embedded in a chip, and the plurality of cores can share tables. Also, the tables can be shared among a plurality of instructions that are executed simultaneously.

Therefore, according to the present disclosure, it is possible to solve energy consumption and heat generation problems in a multi-core architecture processor equipped with a plurality of cores.

Meanwhile, it would be understood by a person with ordinary skill in the art that each of the storage unit 100, the decoder 110, the entry search unit 120, the transmission unit 130, the determination unit 140, and the calculation unit 150 can be implemented separately or in combination with one another.

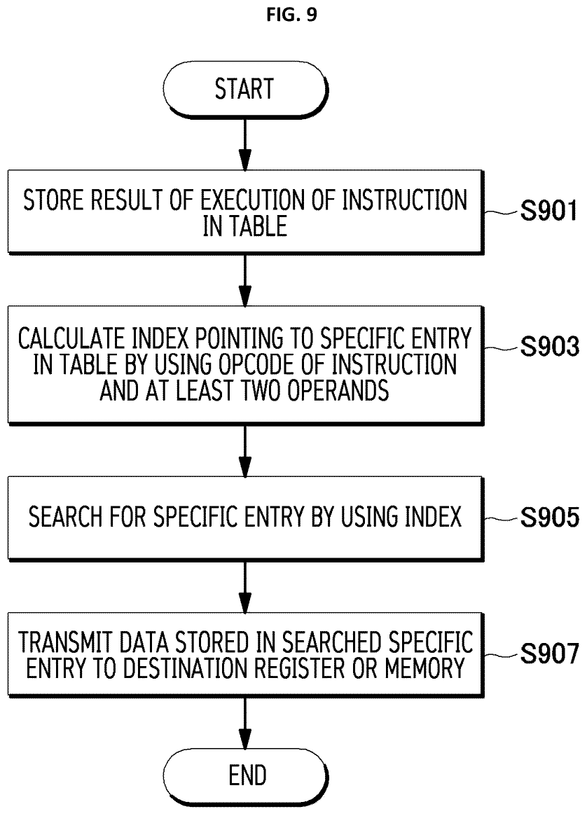

FIG. 9 is a flowchart showing a method for processing an instruction according to an embodiment of the present disclosure.

Referring to FIG. 9, in a process S901, the processor module 10 may store a result of execution of an instruction in a table.

In a process S903, the processor module 10 may calculate an index pointing to a specific entry in the table by using an opcode of the instruction and at least one operand.

In a process S905, the processor module 10 may search for a specific entry by using the index.

In a process S907, the processor module 10 may transmit data stored in the searched specific entry to a destination register or a memory.

In the descriptions above, the processes S901 to S907 may be divided into additional processes or combined into fewer processes depending on an embodiment. In addition, some of the processes may be omitted and the sequence of the processes may be changed if necessary.

The embodiment of the present disclosure can be embodied in a storage medium including instruction codes executable by a computer such as a program module executed by the computer. A computer-readable medium can be any usable medium which can be accessed by the computer and includes all volatile/non-volatile and removable/non-removable media. Further, the computer-readable medium may include all computer storage media. The computer storage media include all volatile/non-volatile and removable/non-removable media embodied by a certain method or technology for storing information such as computer-readable instruction code, a data structure, a program module or other data.

The above description of the present disclosure is provided for the purpose of illustration, and it would be understood by a person with ordinary skill in the art that various changes and modifications may be made without changing technical conception and essential features of the present disclosure. Thus, it is clear that the above-described examples are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A method for processing an instruction, comprising:
storing a result of execution of an instruction in a table;
calculating an index pointing to a specific entry in the table by using an opcode of the instruction and at least one operand;
searching for the specific entry by using the index; and
transmitting data stored in the searched specific entry to a destination register or a memory.

2. The method of claim 1,
wherein the calculating the index includes:
calculating the index through a combine operation by using the opcode of the instruction, the at least one operand, and additional information.

3. The method of claim 1,
wherein the calculating the index includes:
when a plurality of bits included in the at least one operand have a predetermined pattern, calculating the index by using bits other than the predetermined pattern among the plurality of bits.

4. The method of claim 1, further comprising:
determining whether a bit string predictable from the opcode or the at least one operand exists in the table based on a range for the instruction and the at least one operand.

5. The method of claim 4, further comprising:
when the bit string predictable from the opcode of the instruction or the at least one operand exists in the table, storing the remaining bit strings except the bit string in the entry in the table.

6. The method of claim 1,
wherein the calculating the index includes:
calculating a plurality of indices by altering the order of the at least one operand.

7. The method of claim 6,
wherein the searching for the specific entry by using the index includes:
searching the table for entries pointed to by the plurality of indices.

8. The method of claim 7,
wherein the transmitting the data includes:
transmitting the data stored in the searched entries pointed to by the plurality of indices to the destination register or the memory.

9. The method of claim 7, further comprising:
deleting all but one of a plurality of duplicate entries pointed to by the plurality of indices from the table.

10. The method of claim 1,
wherein the at least one operand includes a first operand and a second operand, and
the method further includes:
dividing each of the first and second operands into predetermined sizes and calculating a final result value of the instruction by combining partial products calculated using the divided first operand and the divided second operand.

11. A processor module for processing an instruction, comprising:
a storage unit configured to store a result of execution of an instruction in a table;
a decoder configured to calculate an index pointing to a specific entry in the table by using an opcode of the instruction and at least one operand;
an entry search unit configured to search for the specific entry by using the index; and
a transmission unit configured to transmit data stored in the searched specific entry to a destination register or a memory.
